(19) United States
(12) Patent Application Publication
(10) Pub. No.: US 2014/0002502 A1
(43) Pub. Date: Jan. 2, 2014

(54) METHOD AND APPARATUS FOR OUTPUTTING GRAPHICS TO A DISPLAY

(71) Applicant: Samsung Electronics Co., Ltd., Gyeonggi-do (KR)

(72) Inventor: Kapsu HAN, Thames (GB)

(21) Appl. No.: 13/928,730

(22) Filed: Jun. 27, 2013

(30) Foreign Application Priority Data
Jun. 27, 2012 (GB) 1211415.3

(51) Int. Cl. G06T 11/60

(52) U.S. Cl. CPC G06T 11/60
USPC 345/646; 345/619; 345/660; 345/672

(57) ABSTRACT

A method of outputting graphics to a display comprising: detecting an input from a user representative of an image manipulation request; performing a first image manipulation process on at least part of the retrieved image data set in accordance with the image manipulation request to produce second graphics; outputting the second graphics to a display area of the display; determining that a boundary condition relating to the retrieved image data set has been satisfied, the boundary condition relating to a limit of the retrieved image data set beyond which there is no further element of the retrieved image data set to be displayed; performing a second image manipulation process on at least part of the retrieved image data set to produce third graphics, the second image manipulation process providing a second type of alteration to the retrieved image data set, the second type of alteration being of a different type than the first type of alteration; and outputting the third graphics to the display area of the display.

### CROSS RELATED APPLICATION

This application claims the benefit under 35 U.S.C. §119(a) of a Great Britain patent application filed on Jun. 27, 2012 in the Great Britain Patent Office and assigned Serial No. 1211415.3, the entire disclosure of which is hereby incorporated by reference.

### TECHNICAL FIELD

The present invention relates to a method and an apparatus for outputting graphics to a display.

### BACKGROUND

User interfaces enable users to interact with machines such as computers, mobile phones, and other such electronic or mechanical equipment to perform specified functions.

The use of touch-sensitive displays, more commonly known as “touch screens”, are becoming more important as technology continues to evolve and are becoming popular. Using a touch-sensitive display in a mobile phone may be of particular benefit because it can forego the need for a dedicated keypad, navigation pad and separate display screen. Other types of interfaces such as non-touch interfaces are also evolving and, for example, infra-red, radar, magnetic fields and camera sensors are increasingly being used to generate user inputs.

As such, it has become of primary importance that the user interfaces are intuitive and easy to use. It is also important that they provide feedback and information to the user so that the user is made aware of the actions they are performing.

### SUMMARY

According to a first aspect of the present invention, a method of outputting images on a display includes: displaying at least first image on the display; detecting an input representative of an image manipulation request; performing a first image manipulation process providing a first alternation on a portion of the at least first image in accordance with the image manipulation request to display at least second image; determining whether a boundary condition relating to the at least first image has been satisfied, the boundary condition relating to a limit of the at least first image set beyond which there is no further image to be displayed; and in response to the boundary condition has been satisfied, performing a second image manipulation process providing a second alteration on a portion of the at least second image to display at least third image.

Performing a first image manipulation process comprising a first type of alteration on at least part of the retrieved image data set in accordance with the image manipulation request enables a user to be provided with visual feedback relating to the actions they are performing (i.e. the image manipulation request). Providing a boundary condition and performing a second image manipulation process comprising a second, different type alteration on the retrieved image data set when the boundary condition is satisfied enables the user to also be provided with visual feedback indicative of the boundary condition being satisfied. The different types of alterations are preferably performed on the same image object. As the second type of alteration is different from the first type of alteration, the user is provided with a distinct method of distinguishing between the two forms of visual feedback and therefore can rapidly recognise a difference between the two forms of feedback. As such, the user may be made aware of boundary conditions relating to the functions that the user is trying to perform in a surprisingly effective manner.

By using two different types of geometric transformations, the two different types of graphical alteration may both include movement of graphical elements on the display in correspondence with movement input by a user as the image manipulation request.

The first type of alteration may be a spatially uniform geometric transformation applied to at least part of the image data set and the second type of alteration may be a spatially non-uniform geometric transformation applied to at least part of the image data set.

In this manner, each of the different types of alteration can provide a distinctive effect so as to provide easily recognisable visual indications of the boundary conditions relating to the functions that the user is trying to perform in a highly effective manner.

A characteristic of the non-uniformity of the spatially non-uniform geometric transformation may be dependent on a position of a representation of the user input in relation to the display.

Hence, the spatially non-uniform geometric transformation has position dependency such that, as the user represented input changes position, the transformation evolves. This may be used to create a visual effect suggesting that the user is physically manipulating the displayed graphics and therefore provides the user with effective and intuitive feedback.

The spatially uniform geometric transformation may result in a translation of the first graphics in to direction responsive to the user input to produce the second graphics. Thus, the present invention can be used during scrolling so that the user can, for example, browse through multiple image objects on the display and be made aware of a boundary condition occurring during the scrolling.

The spatially non-uniform geometric transformation may result in a stretching of the first graphics in the general direction of the user input to produce the second graphics. The stretching acts to inform the user that their requested function has reached a boundary condition beyond which the function cannot be performed.

The boundary condition may, for example, relate to no further image objects being available, or the image data for a next image object in a series of image objects being determined to be corrupt, or the image data for a next image object in a series of image objects being determined to be in an unknown format. As the user is made aware of this, they can cease or change the image manipulation request.

The spatially non-uniform geometric transformation may result in a shrinking of the first graphics along two dimensions to produce the second graphics. This could create the effect of zooming out of currently displayed graphics.

The spatially non-uniform geometric transformation may result in a stretching of the first graphics along two dimensions to produce the second graphics. This could create the effect of zooming into the currently displayed graphics.

The spatially non-uniform geometric transformation may result in a warping of the second graphics in the general direction of the user input to produce the third graphics, wherein the degree of warping is dependent on the position of the user input in relation to the display. The warping can provide an indication to the user that a boundary condition has been satisfied.

A release of the input from the user representative of the image manipulation request may be detected during said first image manipulation process, and the second image manipulation process may be performed without further user input to produce the third graphics. Therefore, a translation of image objects can continue after a scroll gesture, in a “free scrolling” type manner, whereby the translation can occur without continued user input.

The second image manipulation process may be reversed without further user input, after the third graphics have been output, to produce fourth graphics. The reversing of the second image manipulation process therefore allows the return of graphics to their previous state. Such a process can create a bounce-like effect to provide an intuitive indication to the user that the boundary condition has been satisfied.

The release of the input from the user representative of the image manipulation request may occur during said second image manipulation process, and the second image manipulation process may be reversed in response to the detected release to produce fourth graphics. The reversing of the second image manipulation process therefore allows the return of graphics to their previous state.

The determination of the boundary condition being satisfied may comprise determining that at least one outer limit of the image data set has met at least one outer limit of the display area. This may be indicative that there is no further data in the image data set for display beyond the graphics displayed when the boundary condition is satisfied.

The image manipulation request may relate to a representative movement of the user input, the representative movement moving on the display towards at least one outer limit of the retrieved image data set. The first type of alteration may comprise a translation of image objects corresponding to the image manipulation request movement, applied to at least part of the image data set. The boundary condition may relate to the at least one outer limit of the retrieved image data set. The second type of alteration may be an image shrinking alteration applied to at least part of the image data set.

The image manipulation request may relate to a representative movement of the user input, the representative movement moving on the display away from at least one outer limit of the retrieved image data set. The first type of alteration may comprise a translation of image objects corresponding to the image manipulation request movement, applied to at least part of the image data set. The boundary condition may relate to the at least one outer limit of the retrieved image data set. The second type of alteration may be an image stretching alteration applied to at least part of the image data set.

The boundary condition may relate to a single outer limit of the image data set, and the second type of alteration may be a one-dimensional image transformation applied to at least part of the image data set.

The boundary condition may relate to two outer limits of the image data set, and the second type of alteration is a two-dimensional image transformation applied to at least part of the image data set.

The image manipulation request may comprise a zoom-out request and the determination of the boundary condition being satisfied may comprise determining that a maximum zoom-out limit, beyond which no further image data set is present, has been reached.

The image manipulation request may comprise a zoom-in request and the determination of the boundary condition being satisfied may comprise determining that a maximum zoom-in limit, beyond which no further image data set is present, has been reached.

The display may comprise a touch-sensitive display and the image manipulation request may comprise a touch-sensitive gesture.

The image data set may include one or more image data portions which are not output on said display area before the image manipulation request is detected.

Therefore, the image manipulation request can be initiated to view image objects that are “hidden” from view.

According to a second aspect of the present invention, an apparatus for outputting graphics to a display includes: at least one processor; a display; wherein operation of the processor causes the apparatus to: display at least first image on the display; detect an input representative of an image manipulation request; perform a first image manipulation process providing a first alternation on a portion of the at least first image in accordance with the image manipulation request to display at least second image; determine whether a boundary condition relating to the at least first image has been satisfied, the boundary condition relating to a limit of the at least first image set beyond which there is no further image to be displayed; and in response to the boundary condition has been satisfied, perform a second image manipulation process providing a second alteration on a portion of the at least second image to display at least third image.

Through the use of first and second image manipulation processes, an apparatus, such as a mobile phone can be used to indicate to a user a performance of various requested functions. The user is therefore provided with an intuitive and easy-to-use device that provides informative feedback relating to the detected user input by the device.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows a top view of a mobile phone according to an embodiment of the present invention;

FIG. 2 shows a schematic diagram of an example of a mobile phone according to an embodiment of the present invention;

FIG. 3 shows a schematic flow diagram of the processes that occur in an example method of an embodiment of the present invention;

FIG. 4a shows a schematic diagram of a first example of a display state according to an embodiment of the present invention, the display outputting first graphics;

FIG. 4b shows a schematic diagram of the first example of a display state according to an embodiment of the present invention, the display outputting second graphics;

FIG. 4c shows a schematic diagram of the first example of a display state according to an embodiment of the present invention, the display outputting third graphics;

FIG. 4d shows a schematic diagram of the first example of a display state according to an embodiment of the present invention, the display outputting fourth graphics;

FIG. 5a shows a schematic diagram of a second example of a display state according to an embodiment of the present invention, the display outputting first graphics;

FIG. 5b shows a schematic diagram of the second example of a display state according to an embodiment of the present invention, the display outputting second graphics;

FIG. 5c shows a schematic diagram of the second example of a display state according to an embodiment of the present invention, the display outputting third graphics;

FIG. 5d shows a schematic diagram of the second example of a display state according to an embodiment of the present invention, the display outputting fourth graphics;

FIG. 5e shows a schematic diagram of the processing which occurs in the second example of a method according to an embodiment of the present invention;

FIG. 6 shows a schematic flow diagram of the processes that occur in an example method of an embodiment of the present invention;

FIG. 7a shows a schematic diagram of a third example of a display state according to an embodiment of the present invention, the display outputting first graphics;

FIG. 7b shows a schematic diagram of the third example of a display state according to an embodiment of the present invention, the display outputting second graphics;

FIG. 7c shows a schematic diagram of the third example of a display state according to an embodiment of the present invention, the display outputting third graphics;

FIG. 7d shows a schematic diagram of the third example of a display state according to an embodiment of the present invention, the display outputting fourth graphics;

FIG. 8a shows a schematic diagram of a fourth example of a display state according to an embodiment of the present invention, the display outputting first graphics;

FIG. 8b shows a schematic diagram of the fourth example of a display state according to an embodiment of the present invention, the display outputting second graphics;

FIG. 8c shows a schematic diagram of the fourth example of a display state according to an embodiment of the present invention, the display outputting third graphics;

FIG. 8d shows a schematic diagram of the fourth example of a display state according to an embodiment of the present invention, the display outputting fourth graphics;

FIG. 9a shows a schematic diagram of a fifth example of a display state according to an embodiment of the present invention, the display outputting first graphics;

FIG. 9b shows a schematic diagram of the fifth example of a display state according to an embodiment of the present invention, the display outputting second graphics;

FIG. 9c shows a schematic diagram of the fifth example of a display state according to an embodiment of the present invention, the display outputting third graphics;

FIG. 9d shows a schematic diagram of the fifth example of a display state according to an embodiment of the present invention, the display outputting fourth graphics;

FIG. 10 shows a schematic diagram of a sixth example of a display state according to an embodiment of the present invention, the display outputting various graphics;

FIG. 11 shows a schematic diagram of a seventh example of a display state according to an embodiment of the present invention, the display outputting various graphics;

FIG. 12 shows a schematic diagram of an example of a display state according to an embodiment of the present invention, the display outputting various graphics.

### DETAILED DESCRIPTION

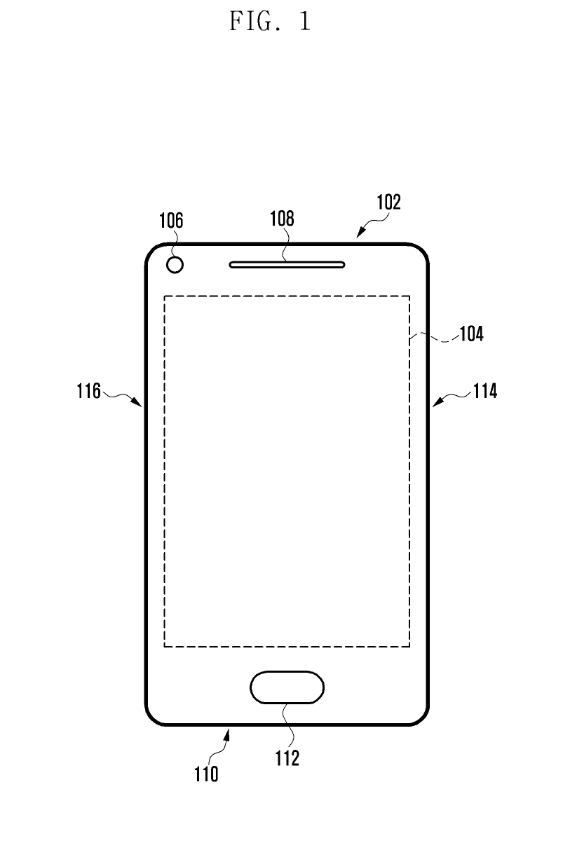

FIG. 1 shows a frontal view of a mobile phone 102 having, in accordance with embodiments of the invention, a touch-sensitive input device, such as touch screen display 104, a front-facing camera 106, a speaker 108, a loudspeaker 110, and soft keys 112, 114, 116. The touch screen 104 is operable to display graphics. The mobile phone 102 may also comprise at least one processor and at least one memory (not shown).

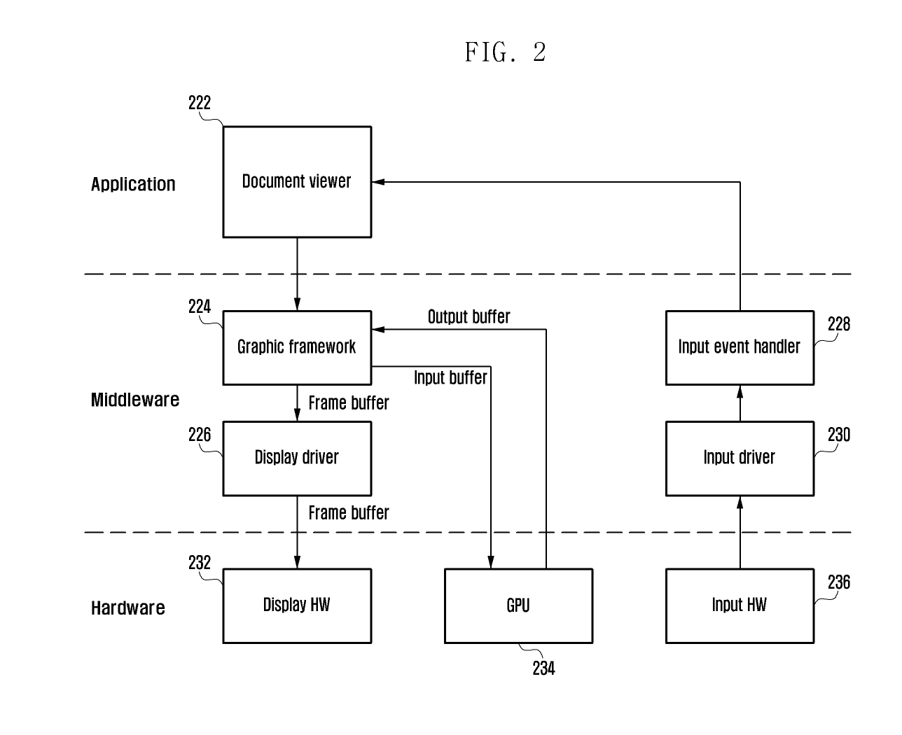

FIG. 2 illustrates a schematic overview of some of the components of the mobile phone 102 which are involved in the process of viewing and manipulating image objects on the mobile phone 102. These components include hardware components such as a Central Processing Unit (CPU) (not shown), display hardware 232, for example the display part of a touch screen display 104, a Graphics Processing Unit (GPU) 234 and input hardware 236, for example the touch-sensitive part of the touch screen display 104. The components also include middleware components which form part of the operating system of the mobile phone 104, including a graphic framework module 224, a display driver 226, an input event handler module 228 and an input driver 230, and a document viewer application 222, which is executed when image objects are to be viewed on the display hardware 233. Note that GPU 234 may be either a hardware component or a software component that is run on the Central Processing Unit (CPU) (not shown). The document viewer application 222 enables interpretation of the touch movement and touch release of a user's input on the touch screen 104, via the input hardware 236, the input driver 230 and the input event handler 228. This input is translated to appropriate parameter values for the graphic framework module 224 to control the GPU 234, which also receives one or more image objects, via an input buffer, which are being viewed using the document viewer 222. The GPU 234 performs graphical transformations on the one or more image objects, or parts thereof, responsive to the input, and stores the resulting image data in an output buffer. The graphic framework module 224 will pass data, from the output buffer, to an input frame buffer of the display driver 226. The input frame buffer may be a direct memory access module (not shown) so that the display driver 226 can pick it up for display. The display driver 226 outputs image data an output frame buffer of the display 104 which in turn outputs it as graphics.

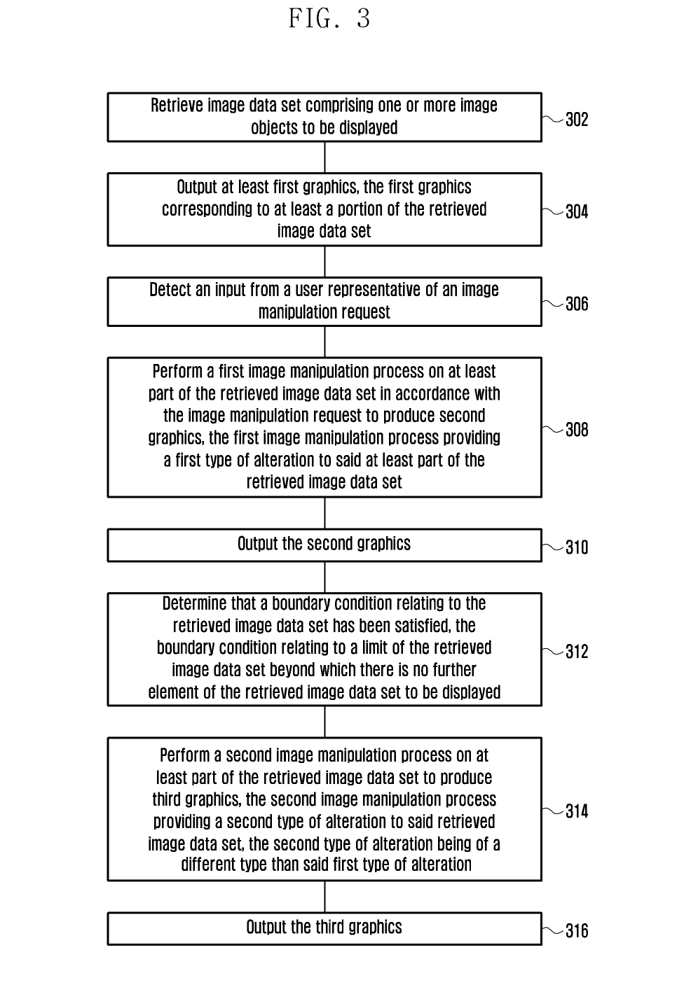

FIG. 3 shows a schematic block diagram of an example of a method according to an embodiment of the present invention. At step 302, an image data set comprising one or more image objects is retrieved from memory (not shown). The image objects relate to image data such as pictures, electronic documents or the like. At least first graphics are determined for outputting to a display in accordance with a function performed by the mobile phone 102, the at least first graphics corresponding to at least a portion of the retrieved image data set, and the at least first graphics are output for rendering on the display 104 (step 304). At step 306, a user input is detected in the form of an image manipulation request. The image manipulation request is associated with a particular function to be performed by mobile phone 102, such that the user can perform various image manipulation requests to perform various associated functions. For example, a first image manipulation request could be indicative that the user wishes to scroll through image objects in a gallery. A second, different image manipulation request could be indicative of the user wishing to zoom in or out of an image object, and so on. At step 308, a first image manipulation process associated with the image manipulation request is performed on at least part of the retrieved image data set in order to produce or generate second graphics resultant from a first type of alteration applied to the at least part of the retrieved image data set. The generated second graphics are representative of the image manipulation request and provides feedback to the user indicative of the action requested by the user via the image manipulation request. For example, in the case that the user wishes to scroll from the currently displayed image object to a next image object in a gallery, the user can slide his finger across the touch screen 104. In response to the user's slide motion across the screen 104, the currently displayed graphics are altered so that the second graphics are output (step 310), which second graphics represent a first image object translating outside of the display area of the screen 104 and a second image object translating onto the display area of the screen 104 as the first image object is translated off the display area, such that the first image object is replaced by the second image object. At step 310, it is determined that a boundary condition has been satisfied. This is where it is determined that the image manipulation request is indicative of a user request to view data in the image data set that is not available. For example, in the case of scrolling through image objects of a gallery, the last image object of the gallery will terminate the scrolling because there would be no further image objects to view, and therefore, if a user attempts to scroll past the last image object, the boundary condition is met. When it has been determined that the boundary condition relating to the retrieved image data set has been satisfied, a second image manipulation process is performed (at step 314) on at least part of the retrieved data set to produce third graphics. This second image manipulation process applies a second type of alteration, different from the first type of alteration, to the retrieved image data set to produce the third graphics. The second image manipulation manipulates the image data set so that the output third graphics (at step 316) provides an indication to the user that no further image data is available for rendering on the display according to the desired function associated with the image manipulation request.

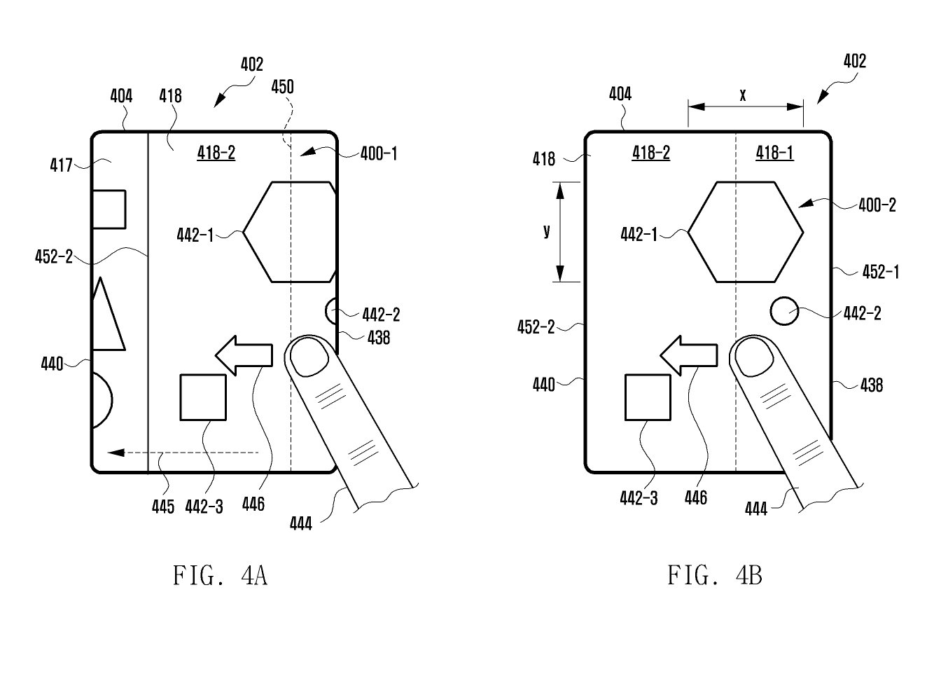

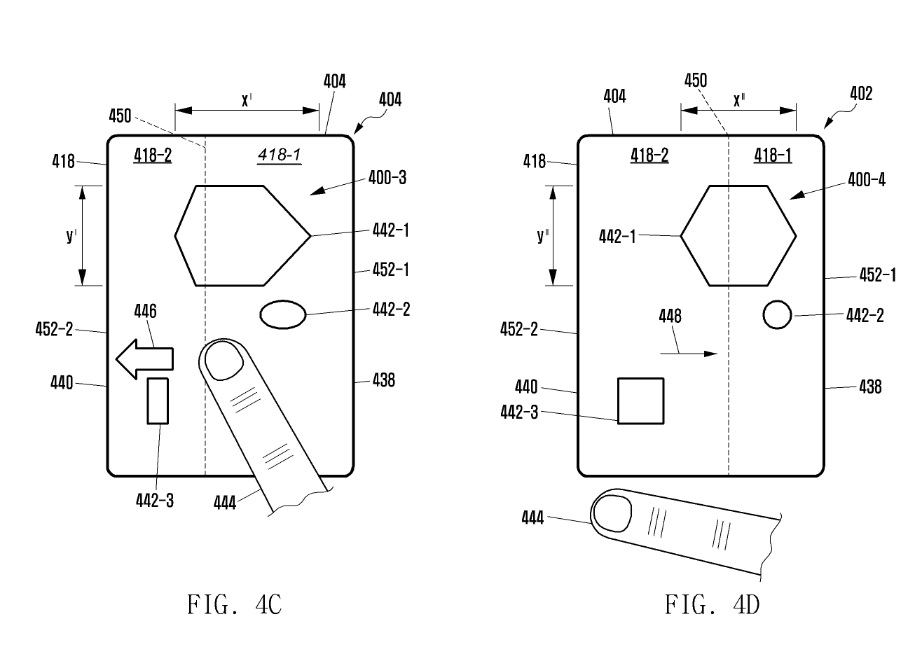

FIGS. 4a, 4b, 4c and 4d show a schematic drawing of the display 402 of the mobile phone 102 of FIG. 1 in more detail. First graphics 400-1 (corresponding to rendered image data from an image data set retrieved from memory) displayed in FIG. 4a illustrate a snapshot of a transition between a first image object 417 and an appended second image object 418. More particularly, the first graphics 400-1 illustrate a portion of the first image object 417 and a portion of the second image object 418 that is appended to the first image object 417. The rendered portion of the second image object 418, more clearly shown in FIG. 4b, comprises multiple features 442 in the form of a hexagon 442-1, a circle 442-2 and a square 442-3. The hexagon has a width denoted as ‘x’ and a height denoted as ‘y’.

As shown in FIGS. 4a, 4b, 4c and 4d, the touch screen 404 is generally responsive to a user's touch (or other object) 444 designed to register an input to the mobile phone 402. Therefore, as the object 444 is brought near or onto the surface of the touch screen 404 and within a detection range of the touch screen 404 surface, the mobile phone 402 senses the presence of the object 444, such as by capacitive sensing, determines the sensed object 444 to be an input and registers the input responsive to the sensed object 444 in order to perform an operation.

As shown in FIG. 4a, the object 444 is first placed near or on the bottom-right region of the surface of the touch screen 404 so that it is sensed by the mobile phone 402. The object 444 is then moved in a slide type motion across the screen 404, whilst maintaining its sensed touch with the screen 404, towards the left side edge 440 of the screen 404, as indicated by motion direction arrow 446. As the object 444 is moved across the screen 404, the mobile phone 402 continues to register the sensed object 444 as an input and accordingly processes the input to determine a corresponding action to take. FIG. 4b illustrates the object 444 having moved a first distance across the screen 404. FIG. 4c illustrates the object 444 having moved across the screen 404 by a second distance, the second distance being greater than the first distance shown in FIG. 4b. FIG. 4d illustrates the object 444 having been removed away or released from the screen 404 so that it is no longer sensed.

The movement of the object 444 on the screen is known as a “gesture”, a “movement request” or an “image manipulation request”. The gesture is a form of user input and has characteristics such as position, direction, distance, and sensed time. The gesture can be one of a number of multiple predetermined patterns or movements that have associated actions or functions that have been programmed into the mobile phone 402 for the mobile phone 402 to take. A mobile phone processor recognises the gesture, and determines, based on the detected or determined characteristics as well as any boundary conditions relating to the retrieved image data set, an appropriate associated action for the mobile phone 402 to take.

In response to the gesture, a first image manipulation process such as an image transformation or deformation is applied to the displayed graphics 400. The image transformation is defined as changing the form of the displayed graphics 400. FIGS. 4a and 4b show a spatially uniform geometric transformation of first graphics 400-1 to provide second graphics 400-2. The spatially uniform geometric translation takes the form of a translation in the general direction 446 of the gesture. FIG. 4c shows a spatially non-uniform geometric transformation whereby the second graphics 400-2 of FIG. 4b are altered such that a portion of the second graphics 400-2 are shrunk along a first dimension, but not in the second dimension, and another portion of the second graphics 400-2 is stretched along the first dimension, thereby providing third graphics 400-3.

The geometric transformations are applied using an algorithm to analyse the displayed graphics 400 and determine how the transformation should occur, depending on the determined gesture characteristics and also depending on conditions of the retrieved image data set used to render the displayed graphics 400. The displayed graphics 400 are then manipulated to provide transformation effects of a translation (in the case of FIGS. 4a and 4b), and a stretch and a shrink (in the case of FIG. 4c). The algorithm operates by, in response to detecting the gesture, determining the initiation point of the gesture (i.e. where the gesture begins) and determining the corresponding spatial point within the displayed graphics 400-1 (and hence the pixel points within the image data set corresponding to the determined spatial point). An intersect line 450 is then associated with the determined corresponding point of the displayed graphics 400-1. The intersect line 450 is a line orthogonal to the general movement direction 446 of the gesture, which line is shown in FIGS. 4a, 4b, 4c and 4d to have a vertical orientation. The intersect line 450 is associated with the gesture such that the intersect line 450 and corresponding displayed graphics 400 move along with the gesture. The entire graphics 400 can thereby be translated in the general direction of the gesture (i.e., in the direction corresponding to the input gesture), in association with the movement of the gesture, to enable the user to scroll through image objects in a gallery, as shown in FIGS. 4a and 4b. The algorithm is adapted to determine when no further image data in the retrieved image data set is available for display (which can be determined either before the outputting of the first graphics 400-1 or second graphics 400-1 or when a boundary condition is met). The algorithm determines or recognises the edges of the last image object 418 and selects the edges of the last image object 418 of which, when the image object 418 is displayed, the gesture is moving towards and away from. The edge that the gesture is moving away from is called the “trailing edge” 452-1. The edge which is in the general direction of the gesture is called the “leading edge” 452-2. The graphical region between the intersect line 450 and the trailing edge 452-1 is defined as the “trailing region”418-1. The graphical region between the intersect line 450 and the leading edge 452-2 is defined as the “leading region”418-2. The algorithm temporarily fixes the trailing edge 452-1 and the leading edge 452-2 to their instant positions (i.e. the respective edges 438, 440 of the graphic display area, the graphic display area being the area on the touch screen 404 that the processor has determined for the display of graphics 400) until an event is flagged indicating that the respective edges need not be fixed any longer. As the leading and trailing edges 452-1, 452-2 are fixed to the edges 438, 440 of the graphic display area, the movement of the intersect line 450 causes the leading and trailing regions 418-1, 418-2 to shrink and stretch in order to accommodate the movement.

In more detail, and as shown in FIGS. 4a and 4b, the first graphics 400-1 are shown to transform by translating in the general direction of the gesture 446. The translation occurs so that the leading edge 452-2 of the image object 418, the trailing edge 452-1 of the image object 418, along with intersect line 450 moves towards display edge 440. In FIG. 4b, the image object 418 is shown to have moved onto the graphic display area thereby having replaced image object 417 on the display 404.

In FIG. 4b, the algorithm determines that the user gesture is indicating a desire to display another image object but that no further image objects are available for output (i.e. the boundary condition is satisfied). A second image transformation process is then applied by the algorithm, in response to the boundary condition being satisfied, to the currently displayed second graphics 400-2 whereby the trailing edge 452-1 and leading edge 452-2 are fixed to the respective edges 438, 440 of the graphic display area and the second graphics 400-2 (which now displays only the image object 418) are transformed in order to output third graphics 400-3. In particular, the algorithm applies a spatially non-uniform geometric transformation whereby the trailing region 418-1 of the last image object 418 is stretched in a first direction in a transverse manner along a horizontal axis as the intersect line 450 moves in the gesture direction 446, and the leading region 418-2 is shrunk transversely to accommodate the stretching of the trailing region 418-1 so that the overall size and shape of the image object 418 is maintained. The stretch is applied linearly so that the image data between corresponding points along the intersect line 450 and the trailing edge 452-1 experience the same degree of stretching. The stretching and shrinking are dependent on the gesture such that, as the object 444 moves, the image object 418 stretches at one end and shrinks at the other end. The amount of stretching and shrinking of the image object 418 increases linearly as the distance travelled by the slide gesture increases but is limited to a critical point beyond which any further stretching would cause an unwanted distortion of the displayed third graphics.

The stretching and shrinking can easily be observed with reference to the shapes 442-1, 442-2, 442-3 in FIGS. 4b and 4c. As shown, the hexagon 442-1 initially has a width of x. After the slide gesture, the hexagon 442-1 width is shown to have expanded to x′, where x′ is greater than x (only the part of the hexagon in the trailing region 442-1 has expanded; the part of the hexagon 442-1 in the leading region 418-1 of the image object 418 has experienced a corresponding shrink). Similarly, the square 442-3 of FIG. 4b undergoes a transformation, however instead of stretching, the square shrinks in the first direction 442-3 so that it becomes a rectangle. Once the object 444 is released, the second image transformation process is reversed to output fourth graphics 400-4 so that the transformed (i.e. stretched and shrunk) image object 418 returns to its original non-transformed state, as shown in FIG. 4d where the hexagon 442-1 width x″ is equal to x. The square 442-3 correspondingly returns to its original shape. The return to the original image object 418 state is gradual and spring-like so that the image object regions 418-1, 418-2 appear to recoil once the object 444 has been released, thereby giving the user an impression that the image object 418 was under the bias of object 444.

As shown in FIGS. 4a, 4b, 4c and 4d, different types of geometric image transformation processes are applied depending on the gesture characteristics and the conditions of the retrieved image data set. The geometric image transformation processes use mathematical transformations to crop, pad, scale, rotate, transpose or otherwise alter an image data array, thereby producing a modified graphical output. The transformation relocates pixels within the image data set relating to the displayed graphics from their original spatial coordinates to new positions depending on the type of transformation selected (which is dependent on the determined gesture). A spatially uniform geometric transformation is where the mathematical function is applied in a linear fashion to each pixel within a selected group of pixels and can therefore result in, for example, a translation of displayed graphics. A spatially non-uniform geometric transformation is where the mathematical function has a non-linear effect on the pixels within a selected group of pixels and can therefore result in an appearance of a stretch or shrink, or other type of warping of the displayed graphics.

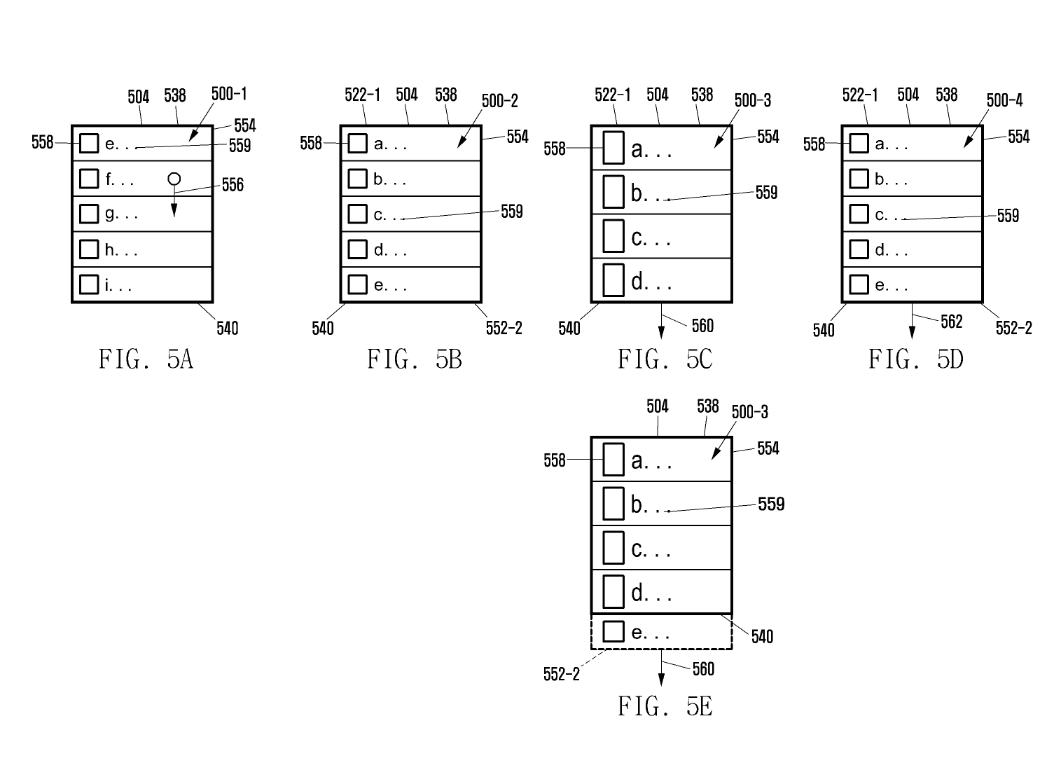

The above embodiments are to be understood as illustrative examples of the invention. Further embodiments of the invention are envisaged, for example, in the above embodiment, it was assumed that the entire first image object 417 and second image object 418 would each occupy the whole graphic display area of the display 404 once they have been navigated or scrolled to. In another embodiment, the first image object corresponding to a picture or electronic document may be larger in size than the graphic display area either in a vertical dimension, a horizontal dimension or in both dimensions. For example, FIGS. 5a, 5b, 5c, 5d and 5e illustrate an image object 554 in the form of a contact list 554 that is larger than the longitudinal axis of the display area of the display 504. The contact list 554 comprises multiple entries of contact information arranged in multiple rows with each contact being represented by an icon 558 and information 559.

Before a gesture to scroll through the contact list is initiated, first graphics 500-1 are displayed in the graphic display area of the display 504 (FIG. 5a). The first graphics 504 relate to part of the image data set that represents a portion of the contact list 554 that does not show the terminus 552-1 (i.e. a portion of the contact list 554 that is away from the beginning 552-1 of the contact list 554 so that the beginning 552-1 of the contact list is not visible in the graphic display area). The scrolling gesture 556 is then initiated and moves in a downwardly direction in order to reveal portions of the contact list beyond the display 504 and towards the beginning 552-1 of the contact list 554, as shown in FIG. 5b. The scroll type gesture may consist of a vertical slide motion in a downwardly direction with a quick release (i.e. the object 444 is not held in place after the slide for longer than a defined threshold time). In response, the contact list 554 begins to translate in the direction of the gesture 556 with a perceived momentum corresponding to the determined characteristics of the gesture, for example, distance and speed. The momentum is dampened so that the scrolling of the contact list 554 slows and eventually stops, depending on the characteristics of the gesture. If the beginning 552-1 of the contact list 554 is not reached after the first scroll gesture, the user can initiate another scroll gesture. The scrolling of the contact list 554 enables portions of the contact list 554 beyond the graphic display area to be revealed by translating (i.e. using a spatially uniform geometric transformation) the displayed first graphics 500-1 in the general direction of the gesture 556 to produce second graphics 500-2.

As shown in FIG. 5c, when the beginning 552-1 is reached and the momentum of the scroll indicates that the scrolling should continue, the contact list 554 is made to briefly stretch (i.e. using a spatially non-uniform geometric transformation) in the direction of the gesture as indicated by arrow 560 to produce third graphics 500-3, before shrinking (i.e. reversing the spatially non-uniform geometric transformation) in the opposite direction indicated by arrow 562 to produce fourth graphics 500-4 (FIG. 5d). The stretch and shrink are applied so that the initial graphics after the shrink (i.e. fourth graphics 500-4) are the same as the graphics before the stretch (i.e. second graphics 500-2).

FIG. 5e shows an example of how the image manipulation process using the spatially non-uniform geometric transformation can be determined. As shown, once the beginning 552-1 of the contact list 554 has been reached, the edge 552-1 representing the beginning of the contact list 554 is fixed to its instant position (the edge 538 of the graphics display area). The contact entry that is furthest away from the edge 552-2 is then pushed beyond opposing edge 540 of the graphics display area so that the portion of the contact list 554 stretches to produce third graphics 500-3. The stretch is gradual. The spatially non-uniform geometric translation is then reversed so that the displayed contact list 554 shrinks to its original non-stretched state, as indicated by fourth graphics 500-4 in FIG. 5d. The transformations produce a stretch-and-recoil type effect or “bounce” effect, whereby the user is provided with an indication that they have reached the beginning 552-1 of the contact list 554 where they can scroll no further.

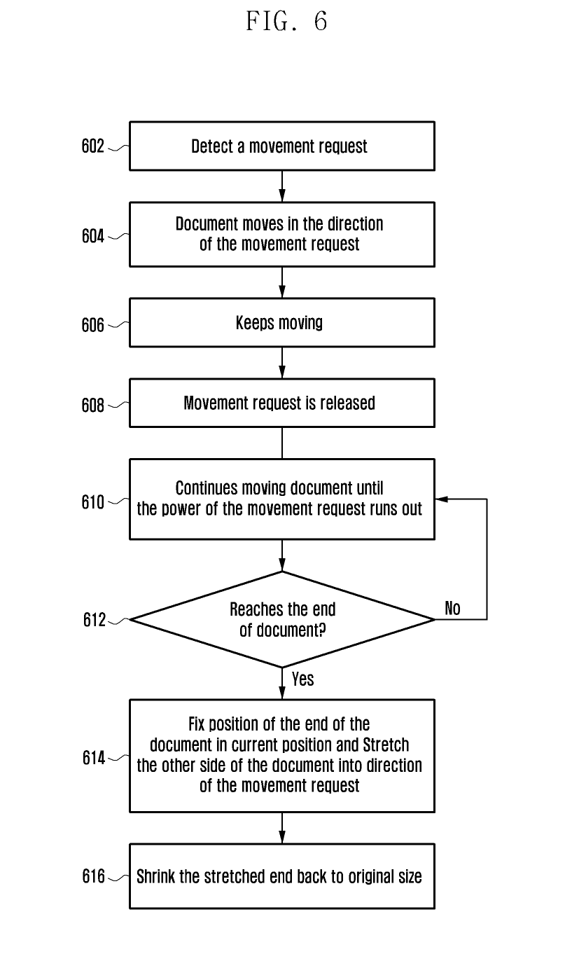

FIG. 6 illustrates a schematic flow diagram of the above contact list 554 embodiment shown in FIG. 5. At step 602, an image manipulation request 556 is detected. The image manipulation request 556 indicates a desire to scroll the displayed contact list 554 in order to reveal hidden or non-displayed portions of the contact list 554. In response to detecting and determining the image manipulation request 556, the contact list 554 or electronic document is translated in the general direction of the image manipulation request 556. The contact list 554 translates in accordance with the image manipulation request 556 by a distance corresponding to the characteristics of the image manipulation request 556 (steps 606, 608 and 610). Once it has been determined that the boundary condition has been satisfied (step 612), the end 552-1 of the contact list 554 is fixed to its current position and the opposing end 552-2 of the displayed contact list 554 is stretched in the direction of the image manipulation request 556 so that it moves beyond the edge 540 of the graphics display area (step 614). The stretching of the contact list 554 is then reversed so that the contact list 554 shrinks back to its original, non-stretched size (step 616). If at step 612, the end 552-1 of the displayed contact list 554 has not been reached, then the scrolling or translation of the contact list 554 continues until either the end 552-1 is reached or the power or momentum of the scrolling motion has run out (step 610).

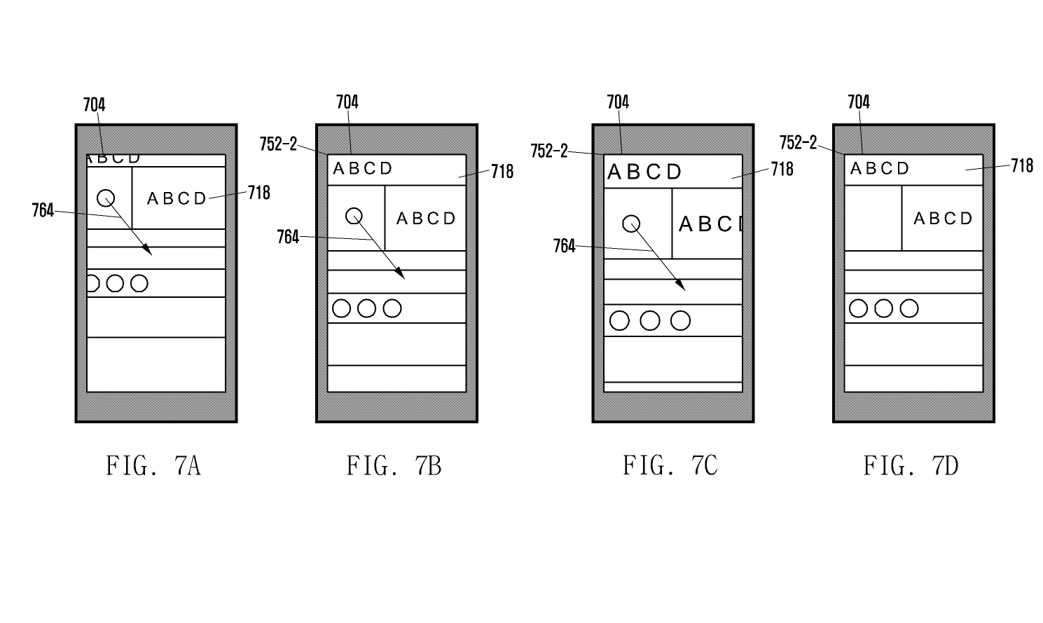

In the above embodiment, in addition to the assumption that the entire first image object 417 and second image object 418 would each occupy the whole graphic display area, it was also assumed that a scroll could only be along a longitudinal or transverse direction of the display. However, in another embodiment, the image object 418 or electronic document may be larger in size than the graphic display area in both directions, and the scrolling motion may have both longitudinal as well as transverse components. For example, as shown in FIGS. 7a, 7b, 7c and 7d, the image object 718 travels or is translated diagonally, along with the movement of the diagonal scroll gesture 764 (FIGS. 7a and 7b). As the corner 752-2 of the image object is reached (FIG. 7b), the displayed portion of the image object 718 is stretched (FIG. 7c) before recoiling (FIG. 7d). The stretching occurs in a similar manner to the above contact list 554 embodiment, but instead of stretching only in one dimension it is stretched in two dimensions.

In the above embodiment, the spatially non-uniform transformations were applied along one dimension. In the diagonal scroll embodiment, the transformation was applied along two dimensions.

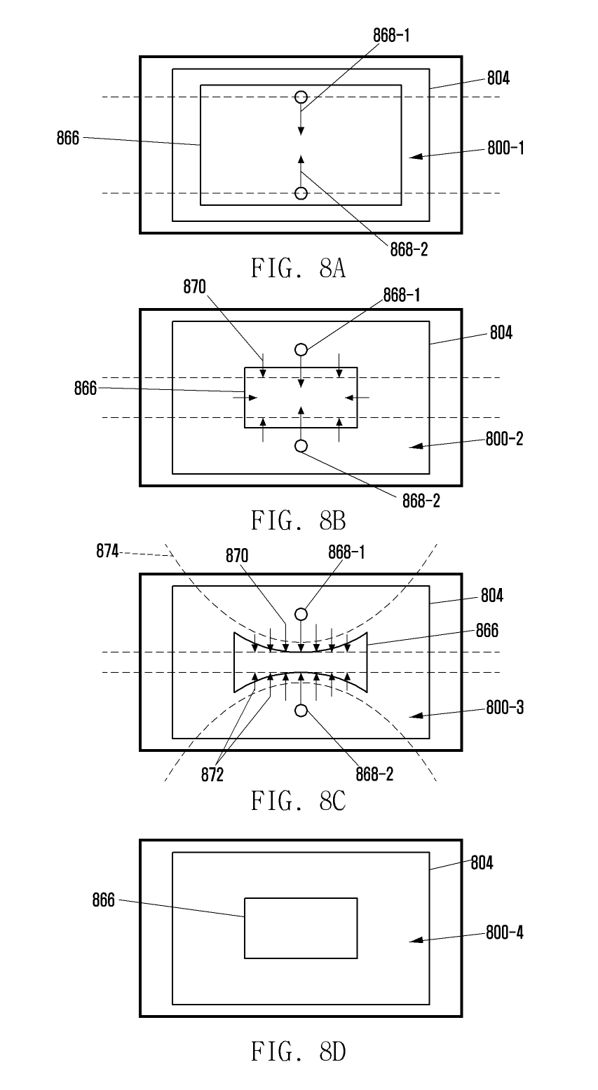

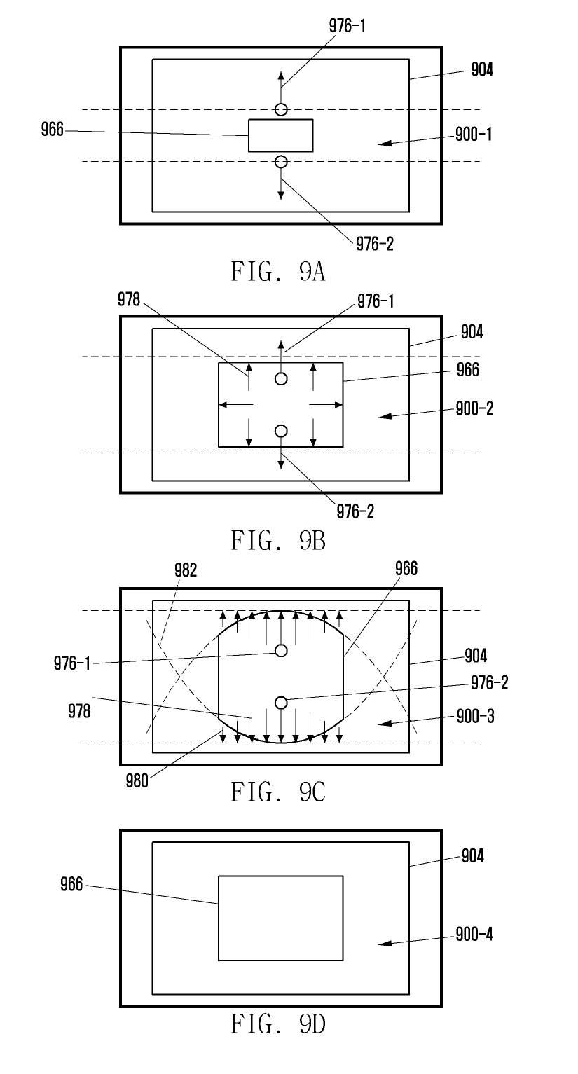

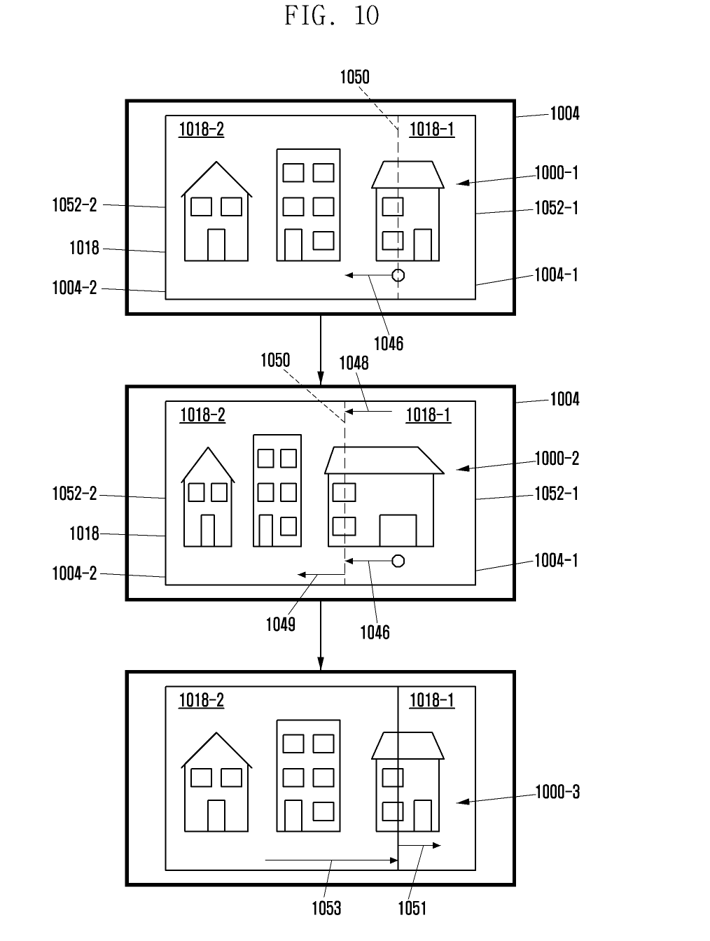

Referring to FIGS. 8 and 9, in other embodiments, the geometric transformation may be applied in a non-linear manner such as to apply a warping effect, as is shown in FIGS. 8c and 9c. For example, the transformation may be substantially radial about one or more points. Therefore, for example, using a “pinch” type gesture, whereby a forefinger and thumb are brought towards each other on the touch screen 804, a user may request to “zoom out” from displayed first graphics 800-1. The pinch gesture is represented by a first user input 868-1 and a second user input 868-2 being brought together on the display 804. As shown in FIG. 8a, a rectangle 866 is displayed by the output first graphics 800-1. As the first user input 868-1 and the second user input 868-2 are brought together, the first graphics 800-1 and displayed rectangle 866 are shrunk along two dimensions so that the aspect ratio of the rectangle 866 remains the same, as shown by the output second graphics 800-2 in FIG. 8b. The shrinking is represented by arrows 870. The amount of shrinking increases until a critical limit is reached, at which point any further zooming in would cause unwanted distortion of the image object. The critical limit may be known beforehand and programmed into the processor, or can be determined by the processor based on the knowledge of the resolution of the image object and the zoom level. Once the critical level has been reached, and if the zoom in request is still being made, a second image manipulation process such as a spatially non-uniform geometric transformation, which is applied to the displayed graphics. The spatially non-uniform geometric transformation can apply a warping to the second graphics 800-2 in order to produce the warped rectangle 866 shown in the output third graphics 800-3 of FIG. 8c. As shown, the warping occurs so that there is a greater amount of shrinking along the direct path between the first user input 868-1 and user input 868-2, represented by arrows 870 and less shrinking on either side of the direct path, represented by arrows 872. The warping shown in third graphics 800-3 is additionally represented by dashed warping lines 874. The warping of the graphics provides an indication to the user that they have reached the maximum zoom in level. The warping effect can be reversed either after a threshold period of time or in response to the user inputs 868-1, 868-2 being released, in order that the rectangle 866 shown by the third graphics 800-3 can return to its original unwrapped state, which is output in FIG. 8d as fourth graphics 800-4. The return of the initially displayed graphics to its original shape is such that the second graphics 800-2 and the fourth graphics 800-4 appear the same.

Similar to the “zoom in” embodiment described above, the user may make an image manipulation request constituting a desire to “zoom out” on displayed graphics. FIG. 9a shows output first graphics 900-1 comprising a rectangle 966. A first user input 976-1 and a second user input 976-2 are shown to move in opposing directions on the display 904, for example when a user places their thumb and forefinger on the touch screen 904 and moves them apart from one another. As shown in FIG. 9b, as the first and second user inputs 976-1, 976-2 are moved apart, a first image manipulation process is applied to the first graphics 900-1 to effect a spatially uniform geometric transformation, which in this case is a stretch in two dimensions so that the aspect ratio of the rectangle 966 remains the same. The enlarged rectangle is output as a part of second graphics 900-2. The stretching is depicted in FIG. 9b by arrows 978. When a critical threshold is reached, indicating that any further zooming in would result in unwanted distortion of the graphics, a second image manipulation process is applied to the displayed graphics. The second image manipulation, as shown in FIG. 9c, applies a spatially non-uniform geometric transformation to the second graphics 900-2 to produce the output third graphics 900-3. In particular, a warped stretching is applied to the second graphics 900-2 such that there is a greater amount of stretching in proximity to the user input points 976-1, 976-2 when compared with adjacent areas. As shown in FIG. 9c, the arrows 978 represent a greater amount of stretching compared with arrows 980. The warping shown on third graphics 900-3 is also represented by dashed warping lines 982. The warping of the graphics provides an indication to the user that they have reached the maximum zoom in level. The warping effect can either be reversed after a threshold period of time or in response to the user inputs 976-1, 976-2 being released, so that the rectangle 966 shown by third graphics 900-3 returns to its original unwrapped state output in FIG. 9d as fourth graphics 900-4 (where the second graphics 900-2 and the fourth graphics 900-4 are the same).

In the above embodiment, a first alteration and second, different alteration was applied to the displayed graphics to effect a translation of the displayed graphics and then a “bounce” of the image object or displayed graphics. In other embodiments, a translation may not be required. Instead, a stretching, shrinking, warping or other type of spatially non-uniform geometric translation may be used to provide the user with an enhanced indication of an action that they are requesting be performed. In particular, after retrieving an image data set comprising one or more image objects to be displayed, first graphics may be output to a display area of the display, the first graphics corresponding to at least a portion of the retrieved image data set. A limit of the retrieved image data set is determined to correspond with a limit of a display area when the at least first graphics are displayed therein. For example, the boundary condition could already be in place when the first graphics are produced, whereby the edge of an image object of the first graphics meets the edge of the graphics display area. An input from a user representative of an image manipulation request to perform a geometric image transformation which goes beyond said limit, such as a slide gesture, is detected. In response to the slide gesture, an image manipulation process is performed on at least part of the retrieved image data set in accordance with the image manipulation request to produce second graphics, the image manipulation process comprising conducting a spatially non-uniform geometric transformation to the at least a portion of said retrieved image data set to provide visual feedback to the user indicating that said image manipulation request is a request to perform a geometric image transformation which goes beyond said limit. The second graphics is then output to the display area of the display.

FIG. 10 shows a schematic example another embodiment of first graphics 1000-1 showing an image object 1018 having a intersect line 1050, a trailing portion 1018-1, and a leading portion 1018-2. The image object has a trailing edge 1052-1 and a leading edge 1052-2. The graphics display area of the display 1004 has a first edge 1004-1 and a second edge 1004-2. A slide gesture 1046 is shown to be initiated moving from the first edge 1004-1 towards the second edge 1004-2 of the graphics display area. The trailing edge 1052-1 and the leading edge 1052-2 are determined as being mapped onto the edges 1004-1, 1004-2 of the graphics display area and are temporarily fixed to their instant positions. The intersect line 1050 moves along with the gesture 1046 such that the trailing region 1018-1 is stretched, as indicated by arrow 1048, and the leading region 1018-2 is shrunk, as indicated by arrow 1049, in order to output second graphics 1000-2. The stretching and shrinking are limited to prevent unwanted distortion to the output graphics. Once the gesture 1046 is completed and the user input is removed, the stretching and shrinking transformations are reversed such that the trailing region 1018-1 shrinks and the leading region 1018-2 stretches to output third graphics 1000-3. The image object 1018 thereby returns to its original state, where the first graphics 1000-1 are the same as the third graphics 1000-3.

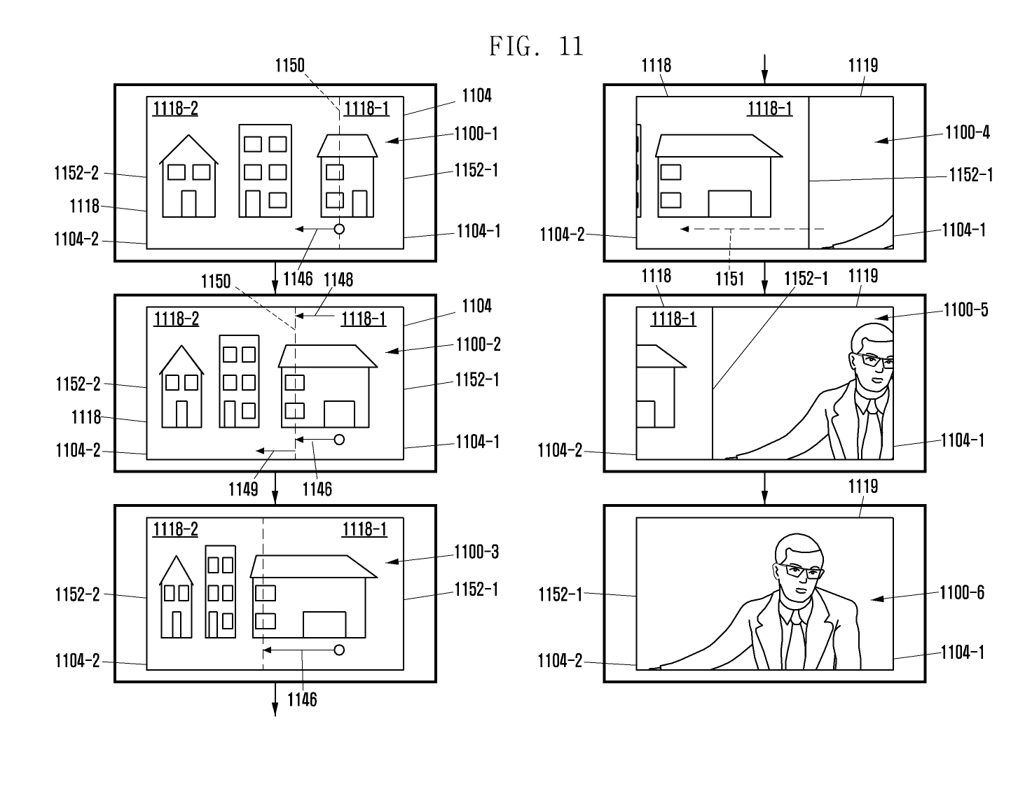

In the example illustrated in FIG. 10, it was assumed that a release of the gesture 1046 would allow the transformed image object 1018 displayed by second graphics 1000-2 to return to its original non-transformed state. In other embodiments, the user may wish to scroll to a next image object upon release of the gesture. FIG. 11 illustrates a transition to a next image object. As shown, output first graphics 1100-1 and second graphics 1100-2 are the same as first graphics 1000-1 and second graphics 1000-2 of FIG. 10. In FIG. 11, the stretch applied to produce the second graphics 1100-2 continues so that third graphics 1100-3 are produced and output, whereby the intersect line 1150 is moved so that the maximum stretching and shrinking limits of the trailing region 1118-1 and leading region 1118-2 are reached, beyond which unwanted image distortion would occur (as determined based on resolution of the image data set or as defined by a programmable limit programmed into the memory of the mobile phone). Once the slide gesture has been completed, the characteristics of the gesture, such as the distance travelled and the calculated speed, are compared with a predetermined threshold (which has been programmed into the memory). If the characteristics of the gesture do not satisfy the threshold, then the image object 1118 returns to its original, non-transformed state by enabling the leading region 1118-2 to gradually expand to its original form and enabling the trailing region 1118-1 to gradually shrink to its original form, similar to what is shown in FIG. 10.

If the processor determines that the threshold has been satisfied, then the processor checks whether a next image object 1119 is available for display. For example, the currently displayed image object 1118 may form a part of an image gallery comprising a sequence of image objects. If there is no next image object 1119 to display, the transformed image is again returned back to its original form (as with FIG. 10). Where both the threshold has been satisfied and also where a next image object 1119 has been determined to be available, an event flag is raised so that the temporary fixing of trailing edge 1152-1 and leading edge 1152-2 is released. The processor then fixes or makes constant the aspect ratios and sizes of the stretched trailing region 1118-1 and the shrunken leading region 1118-2 so that no further transformation is applied to the image object 1118. The next image object 1119 is then appended to the first image object 1118 so that there are no gaps between the image objects. This is done by fixing the left side edge of next image object 1119 to the trailing edge 1152-1 of first image object 1118. The transformed first image object 1118 is then made to transition “off” the touch screen so that it is no longer displayed. As the image object 1118 translates beyond the graphic display area, the left edge of the appended next image 1119 is “dragged” onto the graphic display area to output fourth graphics 1100-4 and fifth graphics 1100-5. The transition between image objects is gradual so that the user is provided with a visual rolling effect.

The threshold is conditional and situation dependent. For example, the threshold may only be relevant when a next image object 1119 is available. In the case of FIG. 11, the threshold is defined as a predetermined distance travelled by the gesture. Therefore, if the gesture is determined to have moved a distance that is equal to or greater than the distance threshold and the gesture 1146 has been released, then a transition to the next image object 1119 is initiated. If the determined gesture distance is below that of the distance threshold and the gesture 1146 is released, then the transformation of the first image object 1118 is reversed so that the first image object 1118 returns to its original state.

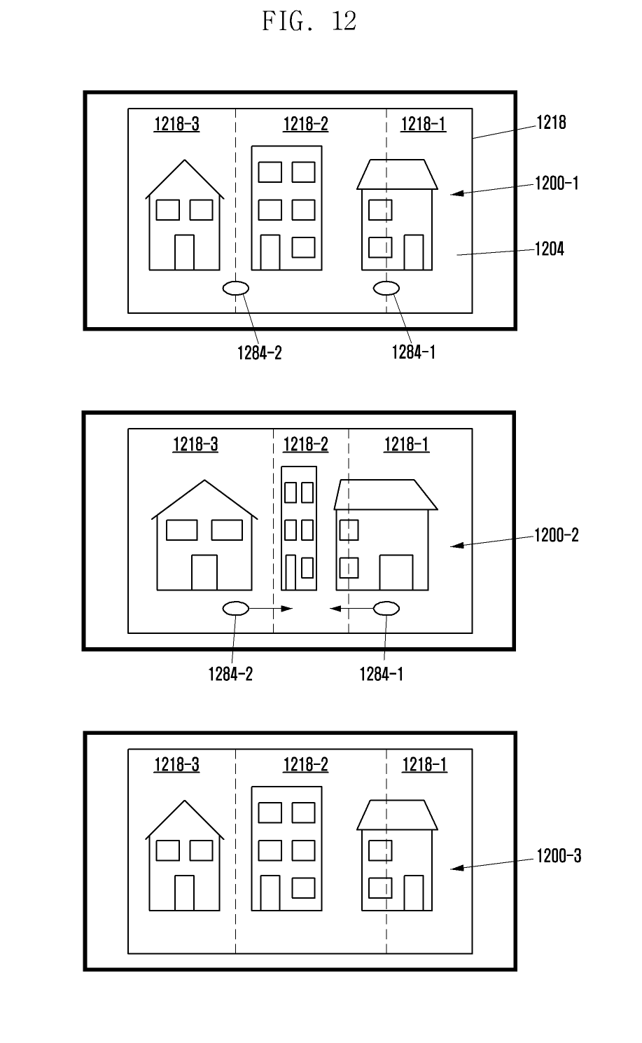

In the above embodiment, a single gesture from a single object 444 was described. In another embodiment, multiple gestures resultant from multiple inputs may be present. In particular, as shown in FIG. 12, a user may bring two objects 1284-1, 1284-2 together on the touch screen 1204 in a “pinch” like motion. The area 1218-2 between the two objects 1284-1, 1284-2 is effectively squeezed and thereby shrinks. The areas 1218-1, 1218-3 outside of the two objects 1284-1, 1284-2 expand so that the overall shape and area of the image object 1218 is retained. Upon release of the objects 1284-1, 1284-2 the image object 1218 returns to its non-deformed state.

In the above embodiment, the threshold was defined as being a distance threshold based on the distance travelled by the gesture satisfying a criterion. In other embodiments, the threshold may be related to one or more of the distance travelled by the gesture, the speed, the latency (time that the user input is held in one position), the position, the velocity or the pattern.

It would be useful if a user could determine whether a next image object is available for viewing before enabling a full transition to the next image object. Therefore, in another embodiment, the processor determines whether a next image object is available before assessing whether the threshold is satisfied. If no next image object is available, the processor applies a stretch and recoil as described in, for example, the contact list embodiment. If it is determined that a next image object is available, the next image object is first appended to the currently displayed image object by attaching the opposing edges of each image object to each other. The currently displayed image object is then translated along with the gesture so that part of the currently displayed image object is translated outside of the graphics display area of the display. When the currently displayed image object is being translated, the edge of the next image object that is appended to the currently displayed image object is allowed to travel with the currently displayed image object whilst the opposing edge of the next image object is retained in its initial virtual position. This initial virtual position corresponds to calculated positional data of the edge of the next image object in the image data set if the appended next image object were to be virtually placed side-by-side the currently displayed image object. The next image object is thereby “dragged” and “stretched” onto the graphics display area of the display. When the object is released, a determination is then made regarding whether the threshold has been satisfied. For example, if more than half of the currently displayed image object has disappeared beyond the graphics display area, then the threshold is satisfied and a transition between image objects occurs, otherwise the currently displayed image object returns to its original position (either by translating over with no stretching or shrinking, or by stretching back to its original position in the graphics display area). The transition involves moving the currently displayed image object beyond the edge of the graphics display area in the general direction of the gesture and dragging the appended edge of the next image object towards the same edge of the graphics display area. The next image object fully transitions onto the screen by allowing the virtual opposing edge of the next image object to be unfixed so that this edge can transition onto the graphics display area, effectively allowing the next image object to shrink onto the graphics display area.

In the above embodiment, it was assumed that the amount of stretching and/or shrinking of the image object would be proportional to the distance travelled by the gesture. However, in other embodiments, the amount of stretching is dependent also on the speed of the gesture. If the gesture is fast and no next document is available, the amount of stretching is limited to prevent unwanted distortion and processing burden. If the gesture is slow and there is no next document available, the processor has more time and therefore can allow the image object to be stretched or shrunk further whilst minimizing unwanted distortion.

In the above embodiment, after the image object has been stretched, the image object was then shown to recoil (if no transition occurred) to the original image object. The recoil action may, in some embodiments, use a damped sinusoidal function (rather than a critically damped function) so that the return to the original image object occurs via a pendulum stretch and shrinking motion with continually decreasing amplitude. This provides the user with the appearance of a “bounce” or spring-like return to the original image object.

In the above embodiment, a particular algorithm was used to apply the stretch and shrinking. In other embodiments, a gesture-dependent convolution function can be applied to the image data of the displayed image object to effect the transformation.

In the above embodiment, a touch screen user interface was used to allow an image manipulation function to be registered and interpreted by a mobile phone and also to provide a visual representation of various graphics. In other embodiments other types of interfaces or displays may be used such as non-touch interfaces and other motion recognition input based system. For example, infra-red, radar, magnetic fields and camera sensors can be used to generate user inputs. The display could be a projector output or any other such system of generating a display.

In the above embodiments, examples were explained with reference to mobile phones. However, in other embodiments, the mobile phone can be replaced with other apparatuses such as PDAs, laptops, desktop computers, printers, tablet personal computers, or any other device or apparatus that uses a visual display.

In the above embodiments, a touch screen was used whereby a gesture and display output utilise the same user interface. In other embodiments, the user interface for the gesture can be separate from the user interface used to provide the display output.

In the embodiments where a linear stretch is applied, there may be a discontinuity present due to the expansion of the space between pixelated image data. In other embodiments, the stretch is applied in a non-linear manner and, for example, using a curved stretch which applies a greater amount of stretching towards one extremity of the output graphics when compared with the opposing extremity.

The above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A method of outputting images on a display, the method comprising:
displaying at least first image on the display;
detecting an input representative of an image manipulation request;
performing a first image manipulation process providing a first alternation on a portion of the at least first image in accordance with the image manipulation request to display at least second image;
determining whether a boundary condition relating to the at least first image has been satisfied, the boundary condition relating to a limit of the at least first image set beyond which there is no further image to be displayed; and
in response to the boundary condition has been satisfied, performing a second image manipulation process providing a second alteration on a portion of the at least second image to display at least third image.

2. The method of claim 1, wherein the first alteration is a first type of geometric transformation applied to the at least first image and the second alteration is a second type of geometric transformation applied to the at least second image.

3. The method of claim 2, wherein the first alteration is a spatially uniform geometric transformation applied to the at least first image and the second alteration is a spatially non-uniform geometric transformation applied to the at least second image.

4. The method of claim 3, wherein a characteristic of the non-uniformity of the spatially non-uniform geometric transformation is dependent on a position of a representation of the input in relation to the display.

5. The method of claim 3, wherein the spatially uniform geometric transformation results in at least one of a translation of the first image in a general direction of the input, a stretching of the first image in the general direction of the input, a shrinking of the first image along two dimensions, a stretching of the first image along two dimensions to produce the second image.

6. The method of claim 5, wherein the spatially non-uniform geometric transformation results in a warping of the second image in the general direction of the input to produce the third image, wherein the degree of warping is dependent on the position of the input in relation to the display.

7. The method of claim 1, wherein performing the second image manipulation process comprising:
detecting a release of the input during the first image manipulation process; and
performing the second image manipulation process without a further input to produce the third image.

8. The method of claim 7 further comprises reversing the second image manipulation process, after the third image have been displayed, to produce at least fourth image.

9. The method of claim 1, wherein the determination of the boundary condition being satisfied comprises determining that at least one outer limit of the at least first image has met at least one outer limit of the display area.

10. The method of claim 1, wherein the image manipulation request corresponds to a representative movement of the input, the representative movement moving on the display towards at least one outer limit of the at least first image, or moving on the display away from at least one outer limit of the at least first image.

11. The method of claim 1, wherein the boundary condition relates to a single outer limit or two outer limits of the at least first image, and the second alteration is a one-dimensional image transformation applied to at least part of the at least first image or a two-dimensional image transformation applied to at least part of the at least first image.

12. The method of claim 1, wherein the image manipulation request comprises a zoom-out request or a zoom-in request, and wherein the determination of the boundary condition being satisfied comprises determining that a maximum zoom-out limit, beyond which no further image is present, or a maximum zoom-in limit, beyond which no further image is present, has been reached.

13. An apparatus for outputting graphics to a display, comprising:
at least one processor;
a display;
wherein operation of the processor causes the apparatus to:
display at least first image on the display;
detect an input representative of an image manipulation request;
perform a first image manipulation process providing a first alternation on a portion of the at least first image in accordance with the image manipulation request to display at least second image;
determine whether a boundary condition relating to the at least first image has been satisfied, the boundary condition relating to a limit of the at least first image set beyond which there is no further image to be displayed; and
in response to the boundary condition has been satisfied, perform a second image manipulation process providing a second alteration on a portion of the at least second image to display at least third image.

14. The apparatus of claim 13, wherein the first alteration is a first type of geometric transformation applied to the at least first image and the second alteration is a second type of geometric transformation applied to the at least second image.

15. The apparatus of claim 13, wherein the first alteration is a spatially uniform geometric transformation applied to the at least first image and the second alteration is a spatially non-uniform geometric transformation applied to the at least second image.

16. The apparatus of claim 13, the processor detects a release of the input representative of the image manipulation request during the first image manipulation process, and performs the second image manipulation process without a further input to produce the at least third image.

17. The apparatus of claim 13, wherein the processor determines that at least one outer limit of the at least first image has met at least one outer limit of the display area.

18. The apparatus of claim 13, wherein the image manipulation request corresponds to a representative movement of the input, the representative movement moving on the display towards at least one outer limit of the at least first image, or moving on the display away from at least one outer limit of the at least first image.

19. The apparatus of claim 13, wherein the boundary condition relates to a single outer limit or two outer limits of the at least first image, and the second alteration is a one-dimensional image transformation applied to at least part of the at least first image or a two-dimensional image transformation applied to at least part of the at least first image.

20. The apparatus of claim 13, wherein the image manipulation request comprises a zoom-out request or a zoom-in request, and wherein the determination of the boundary condition being satisfied comprises determining that a maximum zoom-out limit, beyond which no further image is present, or a maximum zoom-in limit, beyond which no further image is present, has been reached.
